(19) United States
(12) Patent Application Publication
(10) Pub. No.: US 2013/0224337 A1
(43) Pub. Date: Aug. 29, 2013

(54) METHOD FOR FLAVOURING SYRUP

(71) Applicant: Thoma Siegfried, Ludwigshafen (DE)

(72) Inventor: Thoma Siegfried, Ludwigshafen (DE)

(21) Appl. No.: 13/821,128

(22) PCT Filed: Aug. 31, 2011
(86) PCT No.: PCT/EP2011/004401

§ 371 Date: May 6, 2013

(30) Foreign Application Priority Data
Sep. 6, 2010 (DE) 10 2010 044 490.1

(51) Int. Cl. A23L 1/09

(52) U.S. Cl. CPC A23L 1/09
USPC 426/61; 426/418

(57) ABSTRACT

A method for flavouring highly-viscous sugar solution. In said method, a mixture of highly viscous sugar solution and extraction material is filled into a reaction vessel having a filling opening and an outlet opening, the outlet opening being disposed downstream of the filling opening. The mixture consisting of the extraction material and the highly viscous sugar solution is subsequently allowed to mature, lasting at least until an adequate separation of highly viscous sugar solution and extraction material has taken place via the flotation of the vegetable solids. Maturing can be rendered more efficient by optional mixing processes. If honey is not the substance to be flavoured, flavouring can be accelerated by heating. Finally, after the maturation period and separation phase are over, the enriched highly viscous sugar solution is allowed to flow out through the outlet opening. The process can be repeated until the extraction material is exhausted by replenishing highly viscous sugar solution.

### FIELD OF THE INVENTION

The invention relates to a method for aromatizing syrup and honey. Here, a requirement is that the specific weight of the syrup or honey is greater than the specific weight of the extraction material used for enrichment (e.g. solid plant substances).

### BACKGROUND OF THE INVENTION

Approaches to enriching or aromatizing honey are already known from the prior art. For example, DE 199 039 69 A1 by Kaiser, Kristian describes a method for producing a natural food product with honey, wherein solid plant substances are intended to overlay the typical, highly sweet honey taste. The food product described is not a pure honey product, but a mass containing honey which contains solid plant substances that are not obtained from honey. Dehydrated solid plant substances are pulverised, ready-to-use and ready-to-eat honey is warmed until it can be filtered and is mixed with the powder. A plant/honey pulp of a pasty consistency is obtained. The aim is, in particular, to process the solid plant substances and the honey into a homogeneous product which remains mixed. To this end, the honey is warmed, and the warmed mass is filtered and then cooled.

An enriched syrup is also known from DE 10 2006 022 301 A1; the syrup described, which is mixed with fruits or the juice of Prunus laurocerasus (“cherry laurel”), is claimed to have healing properties.

Known pharmaceutical methods such as maceration or percolation use a pure flow process in which the specific weight of the substances used is of no importance.

In particular in case of percolation, the use of an extraction material which is not too finely milled is described, i.e. the grain size should be between 0.8 and 2 mm. Furthermore, due to the tube or funnel-shaped percolators described (described with a ratio of height to average diameter of 5:1), the quantity of the extraction material and solvent processed in an arrangement and processing stage is restricted, since a right-angled profile of a container in a process arrangement always comprises the greatest content when the profile is square, i.e. with a side ratio of 1:1. Accordingly, with an identical base area, a container with a square profile (side ratio 1:1) always has a greater volume than a container with a side ratio of 5:1.

Due to the form of the percolators, there is furthermore a risk that, when the extraction material is compacted during the procedure (e.g. due to subsequent swelling of the extraction material), the flow through the percolator, i.e. the entire process, comes to a halt. Also, during percolation, so-called “frits” (filters made of compacted glass or ceramic) or wadding are used for filtering finest particles. Due to the fineness of a frit and the high viscosity of honey, honey cannot practicably be filtered using a frit. Wadding also becomes sticky when attempts are made to use it to filter honey.

Methods for enriching oils with solid plant substances (e.g. disclosure document DE 1 929 059 A, dated 18 Dec. 1969) cannot be used throughout as a comparison, since the specific weight of oils in general is lower than the specific weight of the solid plant substances which are frequently used as an extraction material.

Furthermore, the Japanese publications JP 59 187 769 A, JP 01 202 264 A and JP 02 312 565 A describe mixtures of honey and other solid plant substances the production of which does in no case include a separation (due to the specific weight) of the honey from the solid plant substances. Furthermore, JP 01 202 264 A describes a warming to 50° C., and JP 02 312 565 A includes a final mixture with a plum pulp (UME/plum cream).

Furthermore, the German Reich patent document DE 604 498 describes an extraction method for the production of fruit and plant essences. Here, however, glycerine acetate is used as an extraction agent.

In the internet nature forum (natur-forum.de), a method for producing a buckthorn plantain cough honey is described. Here, closed jars are used, the handling of which (opening, closing and regular turning) is significantly more complex than the method described below.

WO 02/05663 A1 describes a method in which in the first stage, lemon slices must be left standing in a closed container for 12-16 days. The method described below does not require a corresponding preliminary step.

### SUMMARY OF THE INVENTION

On the basis of this prior art, the object of the present invention is to provide an improved method for aromatizing honey or syrup, referred to below in summary as “highly viscous sugar solution”. This object is attained by a method for enriching highly viscous sugar solution with soluble ingredient substances of an extraction material, wherein the specific weight of the extraction material is lower than that of the highly viscous sugar solution, and the extraction material is present with a suitable granularity, comprising the steps of: filling a reaction container, which has a filling opening and a discharge opening, wherein the discharge opening is arranged downstream of the filling opening, with a mixture of highly viscous sugar solution and extraction material, maturing the mixture of extraction material and highly viscous sugar solution in a maturing phase, until an upper phase of compacted extraction material and highly viscous sugar solution and a lower phase of enriched highly viscous sugar solution are obtained, unfiltered outflow of the enriched highly viscous sugar solution through the discharge opening. Preferred embodiments are described in the sub-claims.

According to the method, the solid plant substances which are used as an extraction material are finely shredded (even down to a grain size of significantly less than 0.8 mm, e.g. finely milled coffee or cinnamon powder) and mixed with the highly viscous sugar solution.

The mixture is filled into a reaction container which comprises a filling opening and, downstream, a discharge opening. The proportions of the reaction container can, in contrast to percolation, be selected in such a manner that low containers are used, but which are large in terms of their volume or standing surface. A ratio of average diameter to height of 1:1 is certainly practicable. This increases the stability of the production arrangement used.

The discharge opening is closed and the mixture is matured, so that advantageously the soluble ingredient substances contained in the extraction material (e.g. essential oils, flavonoids) are transferred to the highly viscous sugar solution.

Due to the different specific weights of the highly viscous sugar solution and the extraction material, a separation occurs. However, the separation takes a certain amount of time to complete due to the high viscosity of the sugar solution. This time period can be assigned to the maturing phase already described.

During this maturing phase, a subsequent swelling of the extraction material occurs to a certain extent. Due to the shape of the reaction container used (i.e. tendentially flat reaction containers, e.g. with a ratio of height to average diameter of 1:1), it is prevented that the arrangement becomes blocked or the process comes to a halt.

Due to the fact that the extraction material is used in powder form, the highly viscous sugar solution is prevented from completely separating from the solid plant substances during the maturing period. Due to the different specific weights of the highly viscous sugar solution and the extraction material, the extraction material collects, however, in a layer in the upper section of the reaction container, while the highly viscous sugar solution settles at the bottom. A complete separation does not occur due to the viscosity and fineness of the powder used.

As an option, an improved distribution of the extraction material in the highly viscous sugar solution can be achieved by regular mixing. The mixing can be done manually or mechanically. Due to the different densities of the highly viscous sugar solution and the extraction material, the extraction material will separate from the honey again.

Following completion of the maturing period, the discharge opening is opened and the settled and enriched part of the highly viscous sugar solution is emptied. At the same time, additional unmixed highly viscous sugar solution is or can be refilled above.

The method is used on honey at room temperature. Warming is not necessary. Thus, it is guaranteed that the ingredient substances of the honey remain as intact as possible. When syrups are used, the ingredient substances of which are stable with regard to warming (e.g. sugar beet syrup), an accelerated and more intense aromatization can be achieved during the maturing period as a result of warming. However, this should only be a part of this method to the extent that the extraction material is not impaired by warming.

A tasty, highly viscous sugar solution is obtained, which can also have a healing effect when the essential oils come from herbs such as thyme or peppermint, so that expectorant substances or those which can ease coughing are for example transferred to the highly viscous sugar solution.

Further exemplary embodiments and some of the advantages associated with this and other exemplary embodiments will be better and more clearly understood in the following detailed description, with reference to the appended figures.

### BRIEF DESCRIPTION OF THE FIGURES

FIG. 1 shows a schematic view of an arrangement of a reaction container in the process phases, namely the filling with the highly viscous sugar solution and the extraction material, the optional mixing procedures, the maturing period and the separation phase, and the out-flow of the highly viscous sugar solution.

FIG. 2 shows the successive phases for further extraction or washing out of the soluble substances. Here, unmixed highly viscous sugar solution is added. The unmixed highly viscous sugar solution mixes with the previously compacted mixture of honey and extraction material due to buoyancy. At the upper edge, a compacted mixture of highly viscous sugar solution and extraction material is again formed, and below, enriched highly viscous sugar solution can again be emptied.

FIG. 3 shows two other embodiment variants, wherein a second discharge has been attached in order to be able to empty insoluble sediment.

### DETAILED DESCRIPTION OF THE INVENTION

In general, the method according to the invention relates to a process for enriching highly viscous sugar solution using active substances and aromatic substances from other food products. Highly viscous sugar solution is understood as being all standard, pourable types of honey (in particular blossom honey, honeydew, forest honey, royal jelly, manuka honey, thyme honey), as well as pourable syrups (e.g. sugar beet syrup, apple syrup, molasses, maple syrup, rice, wheat and barley syrup, agave syrup).

With the method according to the invention, it is furthermore of importance that the specific weight of the highly viscous sugar solution is greater than the specific weight of the extraction material used. Also (particularly in the case of honey), it can be conducted at room temperature. Warming is not mandatory. When syrups are used, however, the aromatization process is accelerated.

An “enrichment” of the honey is understood in such a manner that through the method according to the invention, ingredient substances from the extraction material are transferred to the honey. An aromatization, i.e. the transfer of flavour substances and other active substances, for example of essential oil components with healing properties, can occur. However, the extraction material is not part of the end product obtained by using this method.

Below, the term “maturing period” refers to the period of time from the first contact between the highly viscous sugar solution and the extraction material through to the final separation of both components. In particular, the closing and opening of a reaction container in which the essential part of the maturing period takes place and in which a separation of the highly viscous sugar solution from the extraction material occurs, can also be omitted when the highly viscous sugar solution flows very slowly out of the reaction container. Here, a flow process is realised.

The specific weight and the high viscosity of the sugar solution is thus of significance, since the highly viscous sugar solution is designed to provide a buoyancy to extraction material of such a type that the extraction material is buoyed upwards and thus, a separation of the substances occurs. This separation should not be completed too quickly, however, so that during the maturing period sufficient active substances can be transferred from the solid plant substances to the highly viscous sugar solution.

The shredding of the extraction material, in particular the very fine shredding or pulverisation provided by the method presented, is of significance to the extent that as a result, the reaction speed, i.e. the speed at which enrichment occurs, is greatly increased or boosted. This results from the increase in the active surface area or reaction surface area between the highly viscous sugar solution and the extraction material.

Additionally, when pulverised extraction material is used, no complete separation between the extraction material and the highly viscous sugar solution occurs on the upper edge of the mixture. Complete separation could lead to an impairment of the extraction material within the scope of the method, since the substances to be extracted from the extraction material (e.g. essential oils) could be released into the ambient air and would not be available for the aromatization of the highly viscous sugar solution. Furthermore, the quality of the extraction material could be impaired as a result of oxidisation processes.

Optional mixing procedures increase the efficiency of the enrichment process and can be conducted regularly during the maturing phase.

Following the separation of the highly viscous sugar solution and the extraction material, sieves can be used in order to separate remaining individual elements from the final product, possibly following completion of the maturing and separation process. However, they can in particular be used within the scope of a continuous flow process to control the flow rate in such a manner that an appropriate maturing period, i.e. the aromatization of the highly viscous sugar solution and the separation of the honey and extraction material, is achieved. Here, sieves of all types are suitable, e.g. metal sieves as well as thin cotton cloths. In particular, the entire reaction container can be designed as a sieve, in order to increase the sieve surface and thus the quantity of aromatized highly viscous sugar solution in case of fine-mesh sieves.

The extraction material should consist of solid plant substances. Solid plant substances should here in particular be herbs such as basil, wild garlic, parsley, rosemary, sage, aniseed, fennel, oregano and thyme, or spices such as chilli or cinnamon. Furthermore, the term solid plant substances can also include substances such as coffee, cocoa, tea, dried fruits such as apple or cherries, or dried flowers from roses, lavender and other blooms. However, in relation to this term, fungi such as truffles should also be explicitly mentioned.

It is particularly advantageous when the method according to the invention is conducted with dehydrated plant components, which due to the water reduction more easily release their active and aromatic substances. The solid plant substances can preferably be used in dried and shredded form, wherein the shredding is not restricted in terms of the process used. Naturally, the solid plant substances can also be used as a mixture of several substances of those named above.

Herbs can preferably be used as dried herbs, but also as fresh herbs; the spices can also be fresh or dried spices.

The method according to the invention can advantageously also be conducted in darkness, in order to preserve light-sensitive ingredient substances of the honey or solid plant substances. “Darkness” here means that the process is preferably not conducted under the influence of direct light, i.e. not in sunlight or lamplight. Here, darkening comprises the simple covering of the device with which the method according to the invention is conducted, for example with a light-blocking cloth or a light-blocking film; naturally, it is also sufficient to conduct the method in a room in which no room lighting has been switched on, when the room is lit low or weakly by natural light.

During the aromatization of honey, the absence of quality reduction of the honey can be ensured by the avoidance of warming; warming is generally required with the known technical food product methods, in order for example to produce pourable, filterable honey or to extract the required plant substances.

It is furthermore advantageous that the entire method can also be conducted as a type of flow process. Here, the unmixed, highly viscous sugar solution is refilled at a low speed (e.g. only drop by drop). The refilling should be conducted at the same degree as the discharge of the highly viscous sugar solution.

Overall, the following method stages result: first, a reaction container, which comprises a filling opening and a discharge opening, wherein the discharge opening is arranged downstream of the filling opening, is filled with a mixture of highly viscous sugar solution and extraction material.

Now, the reaction container is closed downstream of the discharge opening when the highly viscous sugar solution has flowed through to the discharge opening. In order to close the discharge opening, a closing lid, rubber stopper, cork, glass stopper or any other suitable closing device can be used. The point of time of closure is of lesser significance, since during the maturing phase, any air bubbles which may have been locked during filling are released upwards out of the reaction container.

Subsequently, the highly viscous sugar solution is left standing with the solid plant substances, in order to complete the so-called maturing period. During the maturing period, a separation occurs between the highly viscous sugar solution and the extraction material on the one hand due to buoyancy. On the other hand, soluble ingredient substances of the extraction material will dissolve.

The maturing period can be extended beyond the actual separation phase. This has the advantage that in the compacted layer of highly viscous sugar solution and extraction material at the upper end of the reaction container, more soluble substances can dissolve.

In order to achieve sufficient aromatization and separation of the highly viscous sugar solution and the extraction material, a maturing period or standing period of the arrangement of between a few hours and a maximum of the shortest shelf life of the honey or the extraction material has been found to be appropriate, depending on the aroma of the respective extraction material.

Naturally, the reaction container need not be closed if the passage and outflow of the highly viscous sugar solution, i.e. the time period from first contact through to final separation, as a whole comprises or exceeds the duration of the maturing period.

During the maturing period, the highly viscous sugar solution and the extraction material or solid plant substances can be regularly mixed, or mixed at intervals, providing sufficient space is available at the lower edge of the reaction container for unmixed highly viscous sugar solution to settle there.

With honey and dehydrated solid plant substances, the separation occurs due to the differing density of the honey (density approx. 1.4 kg/l) and the dehydrated solid plant substances (density <1 kg/l). With syrups, the selection of the syrup and the extraction material should be made accordingly for the method. Also in regard to syrups, the specific weight in general is greater than 1 kg/l, since the sugar has a specific weight of 1.6 kg/l.

Following completion of the maturing period, in particular following sufficient separation between the highly viscous sugar solution and the extraction material, the highly viscous sugar solution is emptied through the discharge opening into the receiving container, or allowed to flow out for further processing (bottling, packaging, etc.).

Then, new highly viscous sugar solution can in turn be refilled from above. The refilling can occur at several points above the reaction container with very large or wide containers. This is designed to prevent a reaction to take place only at one narrowed point during the subsequent mixing, maturing or extraction phase. When refilling, an even distribution of the highly viscous sugar solution above the compacted layer of the highly viscous sugar solution and the extraction material is advantageous.

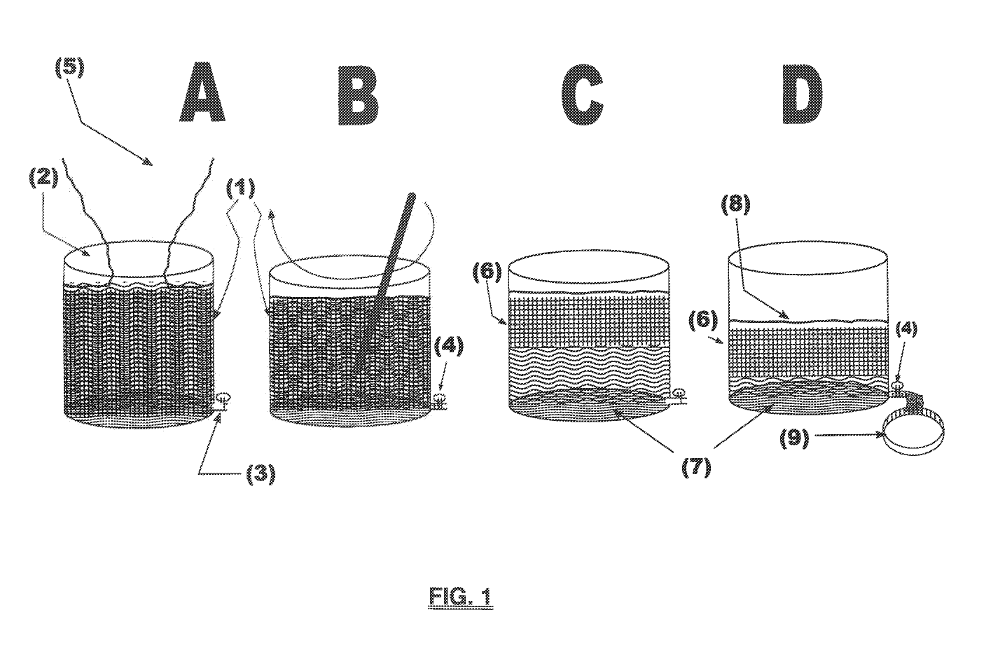

As is shown in FIG. 1, now initially in a phase A, the reaction container 1 is filled up to three-quarters full with a mixture of highly viscous sugar solution and extraction material 5.

Phase B shows an optional mixing procedure. Phase C shows that the highly viscous sugar solution is now sufficiently separated from the extraction material. When a sufficient maturing period has passed and sufficient separation has been achieved, the aromatic highly viscous sugar solution can flow out, as shown in phase D, by opening the discharge tap. As is shown, the enriched highly viscous sugar solution 7 now flows into a receiving container 9.

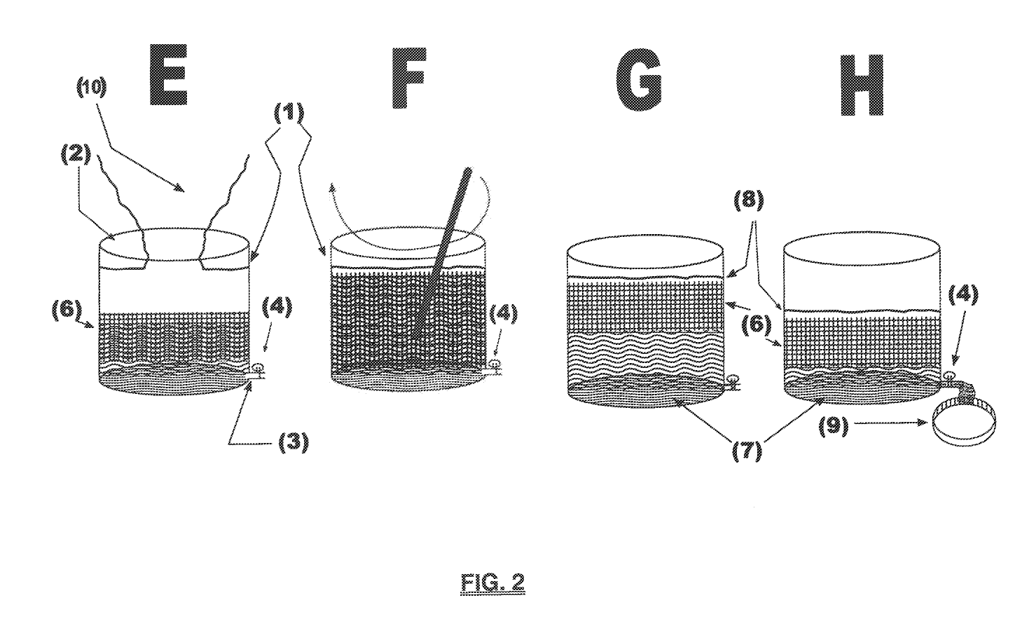

In order to enable further extraction, unmixed highly viscous sugar solution can now be refilled, as is shown in FIG. 2, phase E. As a result of optional mixing procedures (phase F), the efficiency of the enrichment can be increased. The refilled highly viscous sugar solution mixes with the remaining, compacted mixture of highly viscous sugar solution and extraction material. Due to its higher specific weight, the highly viscous sugar solution travels through the compacted mixture of honey and extraction material, and separates again from the extraction material in the lower section of the reaction container (phase G). During phase H, enriched highly viscous sugar solution can again be emptied. Phases E-H can be repeated until the extraction material has been entirely used up. Here, however, the shelf life of the materials used should not be exceeded.

The method can for example be conducted in a round reaction container which may be designed as follows:

The reaction container has a height of approximately 20 cm and a diameter of 15 cm. At the lower end, a squeeze lock is attached (i.e. a run-off with a small hose and a clamp which presses the hose together, inner hose diameter approximately 1 cm).

200 g of finely milled cinnamon and 2 kg of pourable acacia honey are stirred together, in order to obtain an even, homogeneous mass. The entire product enters the reaction container. This results in a filling of approximately 55% (11 cm high). The mixture is left standing for 24 hours. During this time, the honey separates from the cinnamon. The honey and cinnamon can be thoroughly mixed together at intervals of one hour.

After a 24-hour maturing or separation period without mixing, a 4 cm high layer of enriched honey (without additional ingredient substances), on top of this, a 1 cm layer of honey with fine suspended particles and over that, a concentrated layer of honey and cinnamon powder have been formed. Now, 400 g of enriched honey can be emptied.

Now, 400 g of pourable acacia honey is refilled, as a result of which, viewed from below, initially a 1 cm layer of honey, over that a concentrated layer of honey and cinnamon powder, and over that a 2 cm high layer of unmixed honey are obtained.

After other optional mixing procedures and a rest or separation period of 24 hours, the refilled honey has penetrated into the layer with the concentrated honey/cinnamon mixture, and below, a 1.5 cm thick layer of enriched honey without further ingredient substances has formed. Over this, a 2 cm layer of honey with suspended particles and over that, again a 5.5 cm layer of concentrated honey/cinnamon mixture. Now, an additional 400 g of enriched honey can be emptied and the process can begin anew.

Instead of the round container described here, any tub-shaped container can be used, such as a rectangular bowl with a discharge opening.

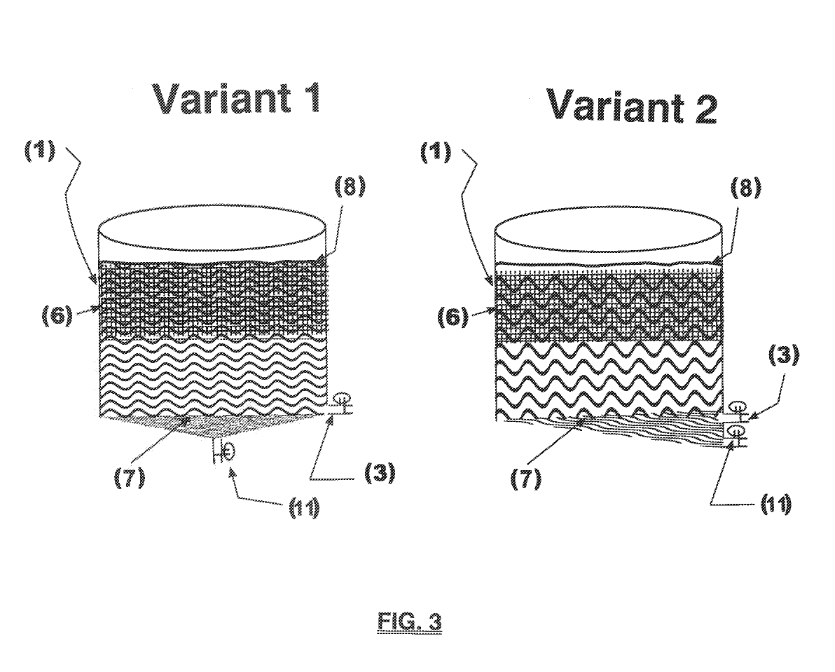

The reaction container can furthermore be provided with two discharge openings, in order to flush out sediment on the bottom of the reaction container (see FIG. 3).

Advantageously, instead of a lid, plug or cork or any other kind of closing device, a tap such as a ball tap, can be arranged on the outlet opening.

### LIST OF REFERENCE NUMERALS FOR FIGS. 1, 2 AND 3

Phases:
A: Filling
B: Optional mixing phase
C: Rest, maturing or separation phase
D: Outflow

Components:
(1): Reaction container
(2): Filling opening
(3): Discharge opening for aromatized highly viscous sugar solution
(4): Closing tap
(5): Entering mixture of highly viscous sugar solution and extraction material
(6): Compacted mixture of highly viscous sugar solution and extraction material
(7): Highly viscous sugar solution, enriched
(8): Level of highly viscous sugar solution
(9): Receiving container
(10): Unmixed highly viscous sugar solution
(11): Discharge opening for sediment

1. A method for enriching highly viscous sugar solution with soluble ingredient substances of an extraction material,
wherein a specific weight of the extraction material is lower than that of the highly viscous sugar solution, and
the extraction material is present with a suitable granularity, comprising the steps of:
filling a reaction container, which has a filling opening and a discharge opening, wherein the discharge opening is arranged downstream of the filling opening, with a mixture of highly viscous sugar solution and extraction material,
maturing the mixture of extraction material and highly viscous sugar solution in a maturing phase, until an upper phase of compacted extraction material and highly viscous sugar solution and a lower phase of enriched highly viscous sugar solution are obtained,
unfiltered outflow of the enriched highly viscous sugar solution through the discharge opening.

2. The method according to claim 1, further including additional mixing procedures during the maturing phase.

3. The method according to claim 1, further including additional refilling procedures with non-enriched highly viscous sugar solution or a mixture of highly viscous sugar solution and extraction material following the emptying of already enriched highly viscous sugar solution.

4. The method according to claim 1, further including a narrowing at the discharge opening, which delays the passage of the highly viscous sugar solution, thus ensuring that an appropriate maturing period is achieved.

5. The method according to claim 1, comprising the steps of
closing the reaction container downstream of the discharge opening wherein the closure can occur before, during or after filling with highly viscous sugar solution and extraction material,
opening a covering following completion of the maturing period.

6. The method according to claim 1, wherein the reaction container comprises 2 discharge openings at the lower end, one discharge opening to enable sediment to be flushed out, and one in order to enable the enriched highly viscous sugar solution to flow out.

7. The method according to claim 1, wherein the extraction material is formed of herbs, spices, dried fruit, coffee, cocoa, tea, fungi, truffles, or a mixture of at least two of the aforementioned solid plant substances or a respective dehydrated form of the solid plant substances, and the highly viscous sugar solution is a syrup comprising sugar beet syrup, apple syrup, molasses, maple syrup, rice, wheat, barley syrup, agave syrup, honey, blossom honey, honeydew, forest honey, royal jelly, manuka honey, or thyme honey.

8. The method according to claim 1, wherein the reaction container as a whole consists of a sieve, a fine mesh of which ensures that an appropriate maturing period is achieved.

9. The method according to claim 1, supplemented by a stage of appropriate warming of the reaction container without disadvantageously impairing the ingredient substances, when honey is not an object of aromatization.

10. The method according to claim 1, characterized in that the maturing period as a whole, even if the refilling phase, maturing phase and outflow phase are repeated, lasts for a minimum of 0.5 seconds, and as a maximum does not exceed a shelf life of honey or extraction material.

11. The method according to claim 4, wherein the narrowing comprises a pure reduction of a profile of the discharge opening or placing a fine-mesh sieve in the discharge opening.

12. The method according to claim 2, further including additional refilling procedures with non-enriched highly viscous sugar solution or a mixture of highly viscous sugar solution and extraction material following the emptying of already enriched highly viscous sugar solution.

13. The method according to claim 12, further including a narrowing at the discharge opening, which delays the passage of the highly viscous sugar solution, thus ensuring that an appropriate maturing period is achieved.

14. The method according to claim 13, comprising the steps of
closing the reaction container downstream of the discharge opening wherein the closure can occur before, during or after filling with highly viscous sugar solution and extraction material, wherein any air bubbles which may have been lock are released upwards with an upward motion of the extraction material, and
opening a covering following completion of the maturing period.

15. The method according to claim 14, wherein the reaction container comprises 2 discharge openings at the lower end, one discharge opening to enable sediment to be flushed out, and one in order to enable the enriched highly viscous sugar solution to flow out.

16. The method according to claim 15, wherein the extraction material is formed of herbs, spices, dried fruit, coffee, cocoa, tea, fungi, truffles, or a mixture of at least two of the aforementioned solid plant substances or a respective dehydrated form of the solid plant substances, and the highly viscous sugar solution is a syrup comprising sugar beet syrup, apple syrup, molasses, maple syrup, rice, wheat, barley syrup, agave syrup, honey, blossom honey, honeydew, forest honey, royal jelly, manuka honey, or thyme honey.

17. The method according to claim 16, wherein the reaction container as a whole consists of a sieve, a fine mesh of which ensures that an appropriate maturing period is achieved.

18. The method according to claim 17, supplemented by a stage of appropriate warming of the reaction container without disadvantageously impairing the ingredient substances, when honey is not an object of aromatization.

19. The method according to claim 18, characterized in that the maturing period as a whole, even if the refilling phase, maturing phase and outflow phase are repeated, lasts for a minimum of 0.5 seconds, and as a maximum does not exceed a shelf life of honey or extraction material.
